(19) United States
(12) Patent Application Publication
(10) Pub. No.: US 2018/0374148 A1
(43) Pub. Date: Dec. 27, 2018

(54) SYSTEMS AND METHODS FOR INCREASING CONSUMER ALIGNMENT IN ONLINE MARKETPLACES

(71) Applicant: EverQuote, Inc., Cambridge, MA (US)

(72) Inventors: C. Deniz AKYUZ, Newton, MA (US); Lei XIA, Wellesley, MA (US); Tomas REVESZ, Lexington, MA (US); Seth BIRNBAUM, Newton, MA (US)

(73) Assignee: EverQuote, Inc.

(21) Appl. No.: 16/012,376

(22) Filed: Jun. 19, 2018

Related U.S. Application Data
(60) Provisional application No. 62/522,997, filed on Jun. 21, 2017.

(51) Int. Cl. G06Q 30/08; G06Q 30/06; G06Q 50/28; G06Q 30/00

(52) U.S. Cl. CPC G06Q 30/08; G06Q 30/01; G06Q 50/28; G06Q 30/0627

(57) ABSTRACT

Disclosed embodiments include methods, systems, and computer-readable media configured to, for example, implement methods for online repeat-auctions. An exemplary method may include receiving, by an input/output module a request from a device of a requestor, the request associated with an electronic source. The request may also include instructions concerning the request from a bidder device of a bidder. Further, the method may include determining, by a quality module, a quality value for the requestor based on the electronic source associated with the request. The method may also include setting, by a bidding module, an amount based on the instructions and the quality value for the requestor. Additionally, the method may include choosing the bidder for the request based on the amount. The method may include delivering, by a tracking module and the input/output module, request information.

### RELATED APPLICATIONS

This application claims priority to and incorporates by reference U.S. Provisional Patent Application No. 62/522,997, filed Jun.21, 2017.

### TECHNICAL FIELD

Embodiments of the present disclosure related to online systems and methods that operate repeat-auctions and adjust bids from bidder systems in order to maximize efficiency in the repeat-auctions.

### BACKGROUND

Online repeat-auctions differ from traditional auctions in numerous ways. In traditional (e.g., non-electronic) auctions, bidders compete to exclusively win a single offer. Once the offer is won by a bidder, the auction is over and a new auction must begin for another offer. Bidders can easily adjust their bids based on factors such as the properties of the items (e.g., quality, brand, style, quantity) and past experience with the items from previous auctions or transactions. These types of auctions are simple to implement, typically do not require computerized implementation, and are relatively straightforward in terms of problems and solutions.

In online repeat-auctions, bidders may repeatedly bid on requests. Bidders may win some requests exclusively, may end up sharing some requests with one or more other bidders, and may not win still other requests. These types of auctions are complicated because of the hybrid win/lose/share nature of the auctions.

The challenges related to online repeat-auctions differ from challenges in typical (e.g., non-electronic) auctions. For example, the continuous nature of online repeat-auctions may lead to statistics-based behavior by bidders, whereby they measure and optimize the performance of their campaigns in a marketplace and modify their bids as appropriate. Bidders may measure and collect aggregated statistics such as average cost per bid or average cost per sale. The quality of such online auctions comes down to fairness—that is, whether the auction provides a stream of correctly matched bidders to correctly matched offerors, all while ensuring the bids affect the win rate without altering the quality of the matches.

In these auctions, bidders need to receive sufficient information to set the correct bid on each auction. Given that these auctions occur on electronic networks, the “source” of the offerors (i.e., how the offeror arrives at the auction) may be included in this information. Typical systems for online repeat-auctions lack a reliable channel to provide this necessary information. Typical systems also lack a reliable manner of learning quality features of the offerors and their alignment to each bidder, based on the properties of the offeror. Learning these quality features would be desirable as it would enable the bidders and the auction systems themselves to efficiently match bidders to offerors.

The present disclosure provides devices, methods, systems, and computer-readable media to solve these and other issues.

### SUMMARY

Disclosed embodiments include methods, systems, and computer-readable media configured to, for example, implement methods for online repeat-auctions.

An exemplary method may include receiving, by an input/output module, a request associated with an electronic source from a device of a requestor and instructions concerning the request from a bidder device of a bidder. Further, the method may include determining, by a quality module, a quality value for the requestor based on the electronic source associated with the request. The method may also include setting, by a bidding module, an amount based on the instructions and the quality value for the requestor. Additionally, the method may include choosing the bidder for the request based on the amount. The method may include providing, by a tracking module and the input/output module, request information.

Systems and computer-readable media implementing the above method are also provided.

Aspects of the disclosed embodiments may include non-transitory and/or tangible computer-readable media that stores software instructions that, when executed by one or more processors, are configured to and capable of performing and executing one or more of the methods, operations, and the like consistent with the disclosed embodiments. Also, aspects of the disclosed embodiments may be performed by one or more processors configured as special-purpose processor(s) based on software instructions that are programmed with logic and instructions that perform, when executed, one or more operations consistent with the disclosed embodiments. Moreover, aspects of the disclosed embodiments may be implemented on specialized (rather than generic) equipment or devices.

It is to be understood that both the foregoing general description and the following detailed description are exemplary and explanatory only and are not restrictive of the claimed embodiments.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is an exemplary network diagram, consistent with disclosed embodiments.

FIG. 2 is an exemplary high-level flow diagram depicting an example repeat-auction, consistent with disclosed embodiments.

FIG. 3 is an exemplary embodiment of auction system, consistent with disclosed embodiments.

FIG. 4 is an exemplary method of implementing a repeat-auction, consistent with disclosed embodiments.

FIG. 5 is an exemplary electronic device, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

Embodiments of the present disclosure are directed to: systems, methods, and computer-readable media for implementing online repeat-auctions. Such online repeat-auctions involve, in part, directing requestors (such as consumers) to bidders (such as good/service providers) to ensure a desired average level of “quality” or fairness to each bidder. One non-limiting example of such an online repeat-auction is an auction for insurance. A consumer may use a device to navigate to an auction website looking to purchase insurance from an insurance provider. Bidders may interact with the auction system to repeatedly bid on numerous requestors. A bidder may win an auction, in which case the bidder and the consumer are put into contact to finalize the sale of insurance. The bidder may also lose the auction or may share the consumer with another bidder.

Disclosed embodiments may add new technical functionality to computerized auction systems. Prior systems may have required bidders to transmit individual electronic messages to explicitly authorize individual bids or a ceiling on bids. Prior systems may also require bidders to tie up their own computer systems to calculate bid amounts to transmit to auction systems. Disclosed embodiments, however, may allow bidders to transmit less information, such as a value proposition, and may allow the bidding system to determine a bid that not only satisfies the bidder's requirements, but also optimizes the bid to meet an objective of the bidder. While bidders may be wary of allowing previous systems to alter their bids, the added functionality of disclosed embodiments may include safeguards to prevent unwanted increases to bidders' bids. And, because disclose embodiments may increase profitability or another value proposition defined by the bidder, bidders may be inclined to make use of disclosed embodiments to reduce the computerized resources bidders would otherwise need to evaluate bids and communicate with computerized auction systems to relay those bids. Therefore, disclosed embodiments may increase the efficiency of processing resources and network bandwidth in computerized auction systems by introducing new functionality to the computer system, having particular network components implement that functionality (so that it is performed as efficiently as possible), including new processes that reduce transceiver processing load on an auction system, and/or implementing processes in certain network locations to reduce bandwidth on the computing system (for both the bidders and the auction system).

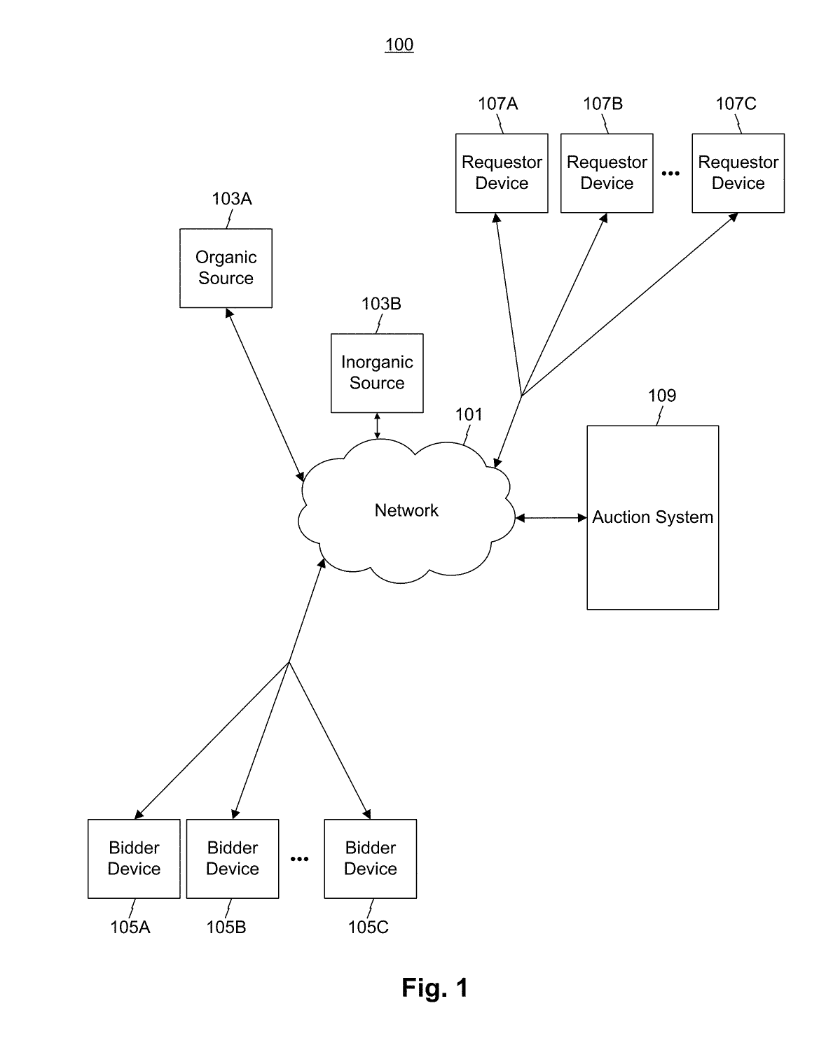

FIG. 1 is an exemplary diagram 100 consistent with the disclosed embodiments. Diagram 100 depicts network 101, at least one organic source 103A, at least one inorganic source 1038, bidder devices 105A-105C, requestor devices 107A-107C, and auction system 109. While certain devices and systems are depicted in singular or plural forms in diagram 100, it is to be understood that other embodiments are possible, and that each of the devices and systems depicted in diagram 100 may be present in singular or plural form in certain embodiments.

Network 101, in some embodiments, represents at least one electronic data network which interconnects electronic devices. For example, network 101 may be implemented as one or more of the Internet, an intranet, one or more private links, or the like. Network 101 may also be implemented as one or more wired or wireless networks. In some embodiments, each of the devices and systems connected to network 101 may communicate using known protocols, such as TCP/IP (Transmission Control Protocol/Internet Protocol) and HTTP (Hypertext Transfer Protocol). For example, a user of requestor device 107A may select on an advertisement displayed on a webpage hosted by a web server (e.g., organic source 103A). This advertisement may be presented as part of a web page and delivered to bidder device by inorganic source 1038. Once the user of requestor device 107A selects the advertisement, requestor device 107A opens a web page hosted by auction system 109 and enables bidding on an auction

Organic source 103A and inorganic source 103B, in some embodiments, represent digital traffic sources through which bidder devices are referred to (e.g., navigate to) auction system 109. For example, a requestor device 107A may arrive at auction system 109 through one of organic source 103A or inorganic source 103B by selecting an advertisement which leads the requestor device 107A, searching for a good offered by bidder device(s) 107A-C, or the like. Each of organic source 103A and inorganic source 1038 may comprise at least one source of digital traffic, such as a website, a social media network, an advertising network, a search engine, a physical item (e.g., a QR code that leads to a website), or the like.

Each source through which requestor devices are referred to auction system 109 may be classified (e.g., by auction system 109) as “organic” or “inorganic” based on the particulars of that source and the mechanism by which the requestor device was referred to auction system 109. For example, organic source 103A, in some embodiments, represents a source through which requestor devices 107A-107C are referred to auction system 109 without compensation by auction system 109 and/or bidder devices 105A-105C. For example, if requestor device 107A reaches auction system 109 through a posting on a social media network (e.g., by interacting with a Facebook™ update posted by auction system 109 or a tweet on Twitter™ posted by bidder device 105B), that social media network would be classified as an organic source 103A. Other “organic” sources (also referred to as “unpaid” or “uncompensated” sources) may include, for example, email marketing systems, search engines which refer digital traffic by way of search engine optimization (SEO), social media posts or networks, or the like.

In contrast, inorganic source 103B, in some embodiments, represents a source through which requestor device 107A-107C are referred to auction system 109 based on compensation by auction system 109 and/or bidder devices 105A-105C. For example, if requestor device 107B reaches auction system 109 through a paid advertisement displayed as part of search results generated by a search engine (known as “search engine marketing” or SEM), that search engine would be classified as an inorganic source 103B. Other “inorganic” sources (also referred to as “paid,” “promoted,” or “compensated” sources) may include, for example, advertising networks, targeted social media or search engine advertisements, other Pay Per Click (PPC) systems, or the like.

Bidder devices 105A-105C, in some embodiments, may be implemented as one or more computerized systems for placing bids on repeat-auctions operated by auction system 109. As one example, bidder device 105A may be operated by a good/service provider, such as a manufacturer or an insurance provider. Bidder device 105A may be configured to generate a bid for a current or future auction operated by auction system 109. In some embodiments, bidder device 105A may receive an indication from auction system 109 indicating that an auction is occurring or will occur soon, and in response, generate a bid for that auction. In other embodiments, bidder device 105A may generate and send a bid without receiving any indications from auction system 109.

Bidder device 105A may also be configured to receive an indication that its bid has won a repeat-auction operated by auction system 109. Such an indication may include information about the won auction (e.g., contact information for a requestor device 107A, price of bid, etc.)

In some embodiments, each of bidder device 105A-105C may be operated by a separate entity (and thus may be implemented as separate computerized systems). In other embodiments, one or more of bidder devices 105A-105C may be operated by the same entity, for example, to enable that entity to submit multiple bids for a single auction. (In these embodiments, one or more of bidder devices 105A-105C may be implemented as separate applications operating on one or more devices, threads of the same application operating on a single device, instances of the same application operating on a single device, or the like).

Bidder devices 105A-105C may generate bids based on information about the request. For example, bidder devices 105A-105C may determine its optimal bid based on the source through which a requestor was referred to auction system 109 (e.g., organic vs. inorganic), based on information about the requestor (e.g., identity, demographics, location, past history of purchases/interaction), based on content of the request (e.g., the particular good/service requested).

Requestor devices 107A-107C, in some embodiments, may be implemented as one or more computerized systems for offering something as part of a repeat-auction operated by auction system 109. For example, requestor device 107A may be operated by or on behalf of a consumer that is seeking to receive offers (in the form of bids) for a good/service that the consumer wishes to purchase.

In one example implementation, diagram 100 may represent a network arrangement for implementing online repeat-auctions that connect insurance providers (i.e., bidder devices 105A-105C) with consumers looking to purchase insurance (i.e., requestor devices 107A-107C). In this situation, consumers may request a quote for insurance given particular constraints (e.g., age of the consumer, type of insurance, amount of coverage) and the bidder devices 105A-105C “bid” on the consumers in an attempt to obtain the consumers as paying customers of their insurance policies. In this implementation, there is likely an infinite number of consumers that can be acquired by any one insurance provider, as the insurance providers have a virtually unlimited supply of insurance policies.

As another example implementation, diagram 100 may represent a network arrangement for implementing online repeat-auctions that connect suppliers (i.e., bidder devices 105A-105C) with consumers or businesses looking to purchase supplies (i.e., requestor devices 107A-107C). In this situation, consumers may request a quote for an order of supplies given particular constraints (e.g., the number of supplies, desired brands or qualities, shipping speed) and the bidder devices 105A-105C “bid” on the consumers in an attempt to obtain the consumers as purchasing customers. In this implementation, there is likely a finite number of consumers that can be acquired by any one supplier, as the suppliers have a finite number of supplies for sale.

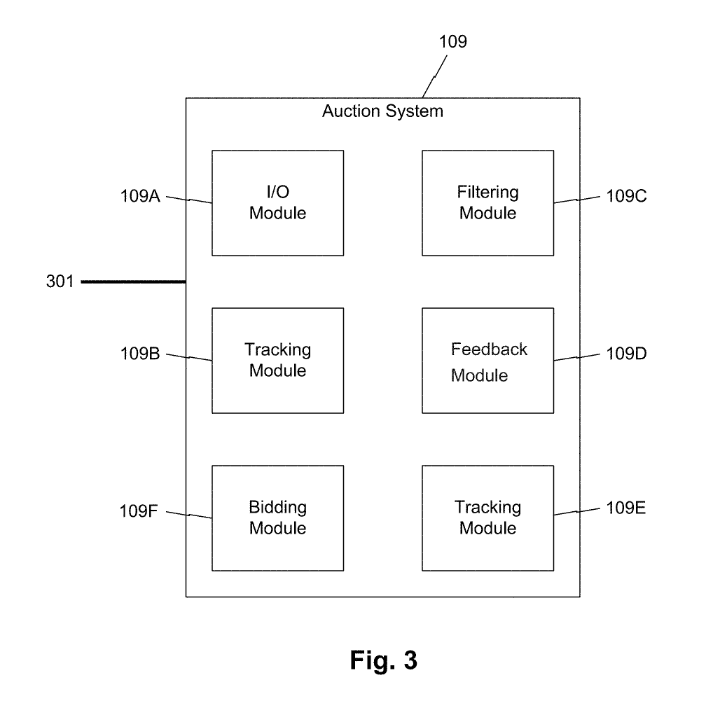

Auction system 109, in some embodiments, may be implemented as a system that operates one or more repeat-auctions. In some embodiments, auction system 109 may be implemented using a plurality of modules that each perform a finite set of tasks that, in conjunction, work to operate a repeat-auction (including initialization of the repeat-auction, running of the repeat-auction, and finalizing the results of the repeat-auction. (One embodiment of some modules of auction system 109 is discussed below with respect to FIG. 3.)

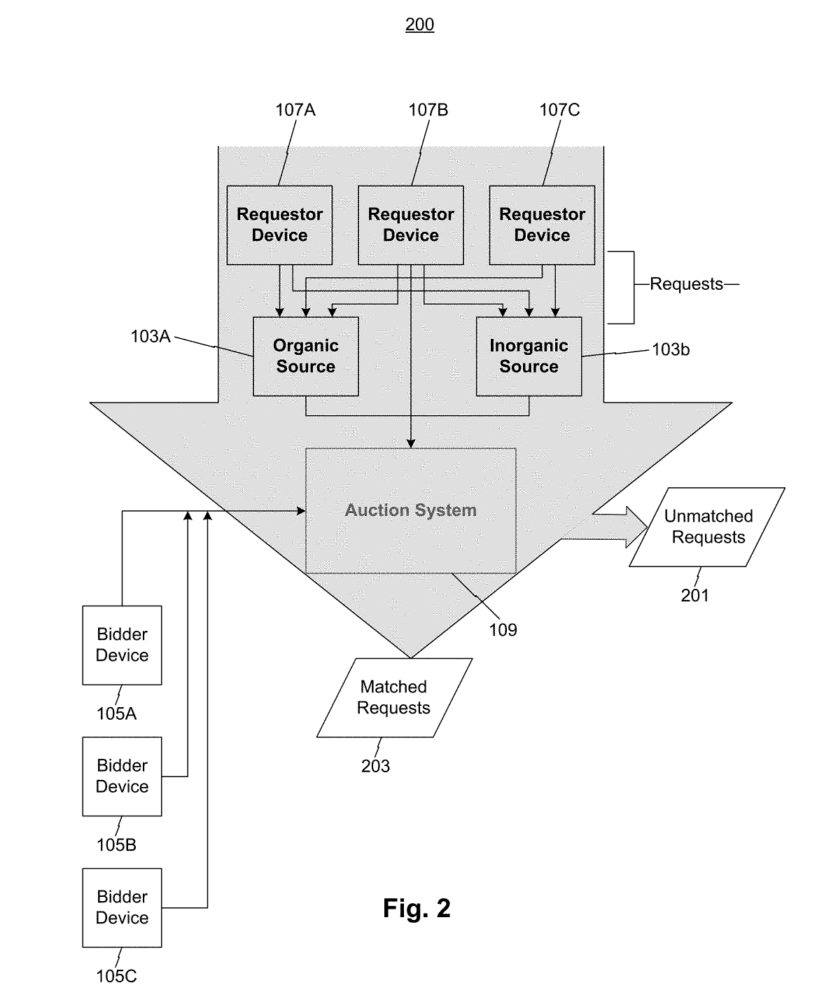

FIG. 2 is a high-level flow diagram depicting an example repeat-auction 200, consistent with disclosed embodiments. Example repeat-auction 200 may begin with one or more of requestor devices 107A-107C requesting a good or service from auction system 109. Requestor devices 107A-107C may request the good or service directly (e.g., by initiating a request to auction system 109) or indirectly (e.g., by navigating to one of an organic source 103A or inorganic source 1038 that refers the requestor device to auction system 109, or by requesting the good or service from a third party which forwards the request to auction system 109). The request may include information about requestor devices 107A-107C, such as a requested item or service from a bidder. Auction system 109 may then forward an indication to bidder devices 105A-105C. This indication can include information received from a requestor devices 107A-107C. Auction system 109 may then operate the repeat-auction. Operating the repeat-auction may comprise matching each request from a requestor device 107A-107C with as many bids from bidder devices 105A-105C as possible. Requests may then be classified as one of unmatched requests 201 (e.g., if a request from a requestor device is not won by a bidder) or matched requests 203 (e.g., if a request from a requestor device is won by a bidder)

At the end of the repeat-auction, auction system 109 may send a communication to any requestor device(s) whose requests make up the set of unmatched requests 201, indicating that the request was not won by any of bidder devices 105A-105C and that the requestor device(s) may send these requests again. (In alternative embodiments, auction system 109 may operate a new repeat-auction with the unmatched requests 201.) Auction system 109 may also send a communication to any requestor device(s) whose requests make up the set of matched requests 203, indicating the bidder device that won the repeat-auction for the requestor device's request.

FIG. 3 is an exemplary embodiment of auction system 109, consistent with disclosed embodiments. In some embodiments, auction system 109 may comprise one or more interconnected modules implemented as software, hardware, firmware, or a combination thereof, that operate repeat-auctions consistent with the disclosed embodiments. Exemplary FIG. 3 depicts I/O (input/output) module 109A, quality module 109B, filtering module 109C, feedback module 109D, tracking module 109E, bidding module 109F, and data link 301. While FIG. 3 depicts exemplary modules 109A-109F, one of skill will understand that other modules and other configurations are possible.

I/O Module 109A, in some embodiments, may be configured to enable communication between auction system 109 and other devices and systems, such as those depicted in FIG. 1. I/O Module 109A may be connected to network 101 via, for example, data link 301. Data link 301 may be implemented as one or more of a wired or wireless network connection to one or more other devices, systems, or networks.

Quality Module 1098 may be configured to determine a “quality” value for each incoming requestor (e.g., a customer seeking a service or good from a bidder). In some embodiments, the terms “quality” and “quality value” refer to a measurement related to a particular requestor (such as a consumer) that relates in part to how likely that requestor is to make a purchase from a particular bidder. This value may be used to measure a sense of “fairness” for ensuring that all bidders are able to participate and win some level of repeat-auctions. For example, the quality value can be used to ensure that a bidder cannot win all repeat-auctions by simply outbidding every other bidder every time. The use of a “quality value” may be used to ensure a fairer distribution and a more efficient repeat-auction process.

In some embodiments, the quality value associated with a requestor may be associated with a set of actions performed by a requestor. Such actions may comprise predetermined types of interactions of the requestor with the bidder, the bidder's services, or the bidder's goods. These actions may, in some embodiments, provide a measure of how much the requestor has interacted with the bidder in the past and how closer the requestor is/was to making a purchase from a bidder. In this sense, the “quality value” is related to a “value to the bidder.” Continuing the above insurance auction example, one sample action type, “quote-started,” may represent whether the requestor has shown interest in working with the bidder by submitting contact information online or over the phone. Another example action, “quote-complete,” may represent whether the consumer has continued far enough in the process of purchasing insurance to receive a quote from the bidder. A “purchase” action may, in some embodiments, be the most valuable action to the bidder. Each of these actions may relate to a different “quality value” (per bidder, per industry, or the like) given that each one has a different (potential or actual) value to the bidder.

The types of actions and the value of these actions to the bidder may depend on the industry and the type of business. For example, in the insurance business, where leads may be followed up by emails or telemarketing, a “quote-start” action may be a valuable action for the bidder. In other business, such as where bidders sell goods online, a “quote-start” action may be of less value to that bidder.

Data used to determine quality of a particular action with respect to a particular requestor—e.g., how much interaction a particular bidder receives from such actions—may be received via an automated or a manual process. One example manner of receiving such data may comprise automated processes, such as by using cookies or other signatures/tracking identifiers known in the art. Another exemplary manner of receiving this data may comprise inserting tracking data (e.g., a tracking code) into communications sent between devices, to enable auction system 109 to track how often requestor devices 107A-107C respond to offers from bidder devices 105A-105C. Another example may comprise manual processes, by which the value of each action may be manually input or selected.

Certain embodiments may calculate quality based on one or more separate scores, such as scores for “intent” and alignment.” With regard to intent, disclosed embodiments may calculate or receive a numerical score (e.g., a fraction, a whole number within a predetermined range) that indicates how likely a consumer will make a purchase and how close in time that purchase may take place. As for alignment, disclosed embodiments may calculate a numerical score that represents the affinity between the consumer and provider (e.g., the bidder), which may account for such factors as prior dealings between the consumer and provider, the frequency of any dealings, the duration of any dealings, and/or the duration time from the first dealing to present time.

In the example context of an insurance provider, disclosed embodiments may calculate a higher alignment score when the consumer corresponds to a type of consumer to which the provider caters. For example, an insurance provider may specialize in providing insurance products to “premium” or low-risk consumers. In this example, the insurance provider may be more skilled at estimating the risk and assessing premiums for “premium” consumers. However, they may be less skilled at and/or offer less competitive pricing options for higher risk consumers. In this example, the premium consumer may have greater affinity to the premium insurance company due to its competitive pricing for that type of consumer. And, the premium insurance company may have greater affinity for the premium consumer because it is skilled in evaluating risk for those types of consumers. In other examples, the reverse may also be true: certain insurance providers may specialize in higher risk consumers.

Certain embodiments may calculate quality as the product of the scores for “intent” and alignment.” For example, auction system 109 may use the following formula to calculate quality:

Qᵢⱼₖ=Iᵢⱼₖ·Aᵢⱼₖ

where Qᵢⱼₖ is may represent the assigned quality score of the consumer Cᵢⱼ from source Sᵢ with intrinsic properties j for the bidder (k). In this equation, Iᵢⱼₖ may represent the intent score and Aᵢⱼₖ may represent the affinity of the consumer to the bidder.

Other information related to quality includes the particular source by which a requestor device was referred to auction system 109. Incorporation of the sourcing method into the quality assignment allows mixing consumers from various sources into a steady flow of biddable units with constant quality. In some embodiments, the sourcing method may factor into the quality value of a requestor using an independent multiplicative factor or a non-linear function. The output of such a process to assign quality may be represented mathematically as a computed quality score Qᵢⱼₖ for each consumer Cᵢⱼ from source Sᵢ for a given bidder Bₖ. Different algorithms factors that go into the computation may result in different quality scores. For example, if the requestor's demographic information factors into the computation, then similar consumers may have the same quality for a given bidder regardless of the source Sᵢ; i.e., Qₘⱼₖ=Qₙⱼₖ (where m and n signify different sourcing methods for the same consumer, j, and given bidder, k). In other embodiments, where the sourcing method is used as the only quality differentiation, the algorithm would assign different quality scores for similar consumers from different sources for the same bidder; i.e., Qₘⱼₖ≠Qnₙⱼₖk. In these embodiments, consumers from the same source would have the same quality score for a given bidder; i.e., Qᵢₘₖ=Qᵢₙₖ where m and n signify different consumers from the same source, i.

Filtering Module 109C may be configured to filter out particular bidders and/or modify received bids, a subset of received bids, or a subset of the effective bids. In some embodiments, effective bids may represent bids used in auction system 109 for purposes of competition, but are not actual payouts. In other embodiments, effective bids may be the bids themselves which are the payouts expected at the delivery. For example, effective bids could be a percentage of a winning bid, the second highest bid, or other non-winning bids. Certain embodiments may perform filtering in order to equally distribute requests to bidders. In some embodiments, filtering module 109C may be configured to filter bids based on a hard (i.e., strict) quality threshold. For example, if the delivered quality is below a set threshold for a bidder, that bidder can only win consumers whose quality assignment is higher than the threshold. In some embodiments where filtering is based on a hard threshold, a bidder will not participate in the auction if the quality assigned to the requestor is below the bidder's quality threshold and the total quality delivered to that bidder is below that threshold.

Feedback module 109D may be configured to analyze data from various sources. The feedback measured by the feedback sources may be direct feedback from the bidders per won unit. In other embodiments, feedback may comprise aggregate feedback over a specified set. Surveys (e.g., sent to requestors) can also be used as feedback sources.

A statistical aggregation of delivered quality for the bidders may also take many forms. One form of statistical aggregation would be a statistical average of quality Dₖ, for a given window:

$${D}_{k} = \frac{{\sum }_{i , j ∈ {W}_{ijk}} {Q}_{ijk}}{{\sum }_{i , j ∈ {W}_{ijk}} 1}$$

where Wᵢⱼₖ specifies the requestors i delivered to bidder k within a defined window (e.g., 24 hours) from source j.

Another example of an aggregation is one where the older events are counted weighed less compared to the latest events. One such example is an exponential decaying average, represented mathematically as:

Dₖ′=α·Qᵢⱼₖ+(1−α)·Dₖ

where Dₖ′ is the updated total quality delivered to bidder k after it won the bid for consumer i with quality Qᵢⱼₖ;
Dₖ is the delivered quality before that delivery; and
α∈[0,1] is a decaying constant.

Other embodiments of maintaining and gathering feedback data are possible as well.

Bidding module 109F may be configured to determine or modify pricing of bidders' bids. In certain embodiments, bidding module 109F may utilize bidding instructions received form a bidder and combine the instructions with the quality score to determine a long-term value of the consumer to the bidder(s), which can then be used to determine a bid that increases, or maximizes, long-term profit for the bidder(s).

In certain embodiments, the bidding instructions may provide sufficient information for bidding module 109F to determine a bid value and set an actual bid. For example, instructions may include a long-term value, an exact bid, and/or a first conversion value. Instructions may also include additional factors, including a budget that limits the number of wins in a predetermined time period or instructions to spend a predefined budget amount. In the example of a predefined budget amount, the instructions may indicate that the budget should be spent to win bids as quickly as possible, the budget may be spent to ensure a constant throughput during a given time period or interval, and/or other budget expenditure limitations. In some embodiments, bidding module 109F may receive the value proposition data through other communication means. For example, when the quality feedback form a given bidder does not provide any value information, the bid instructions from that bidder may contain the value proposition of the consumer to the bidder. In still other embodiments, bidder information may be set in advance or retrieved by bidding module 109F from a database. For example, a bidder may include a store profile in a database that is accessed by bidding module 109F to determine value proposition information for different types of bidders, budget expenditure information, and the other factors previous discussed.

Disclosed embodiments may use equations to calculate the long-term value of a customer. In some embodiments, bidding module 109F may use the expected value proposition for a bit to determine a long-term value or first conversion value of a bid, using a known win-rate based on goals of a bidder. A bidder's goals may include, for example, to maximize profit (e.g., maximize the difference between revenue and costs), to achieve a certain target margin (e.g., maintain a given ratio between revenue and costs), and/or to meet a budget spending with lower limits on margin (e.g., spend the budget without margins falling below a lower threshold). For example, bidding module 109F may calculate long term value using the following formula:

$${LTV}_{ijk}^{expected} = {γ}_{ijk} \cdot {\sum }_{λ ∈ {L}_{ijk}} {v}_{ijk λ}$$

where LTVᵢⱼₖ^{expected} is the expected long-term value and for a given consumer, Cᵢⱼ, from source, Sᵢ, with attributes, j, given the bidder, Bₖ. Further, Lᵢⱼₖ may represent all the expected conversion events within the life expectancy of the consumer-bidder relationship, and v_{ijkλ} may represent the expected earnings of the bidder, Bₖ, from the consumer, Cᵢⱼ, within that life expectancy.

Additionally or alternatively, certain embodiments may calculate estimations of the expected initial value. For example, bidding module 109F may calculate expected initial value using the following formula:

Vᵢⱼₖ^{expected}=γᵢⱼₖ·vᵢⱼₖ^{initial}

where Vᵢⱼₖ^{expected} represents the expected earnings from initial conversion, based on the product of γᵢⱼₖ (e.g., the conversion rate) and νᵢⱼₖ^{initial} (e.g., the expected initial earnings).

Disclosed embodiments may make sure of either or both of the value propositions (e.g., long-term value and/or initial value) to fulfill an optimization goal. Additional types of value propositions may also be used, such as a truncated long-term value, which may be a long-term value over a predefined period. For example, bidding module 109F may calculate a long-term value summation over a limited set of expected conversion events, such as a specific number of expected conversion events and/or expected conversion events that are expected to occur in a given time period (e.g., one month, two months, three months, six months, nine months, one year, two years, five years, ten years, any predetermined number of days, any predetermined number of months, and/or any predetermined number of years).

Disclosed embodiments may utilize a defined relationship between a given value proposition and optimization goal. For example, bidding module 109F may calculate an optimal bid using the following formula:

Pⱼₖ=Rⱼₖ·(vⱼₖ−bⱼₖ)

where Pⱼₖ may represent the profit rate, Rⱼₖ may represent the win rate, and vⱼₖ≥bⱼₖ represent bids (e.g., in a rational application). In this example calculation, information regarding the source, Sᵢ, has been integrated out to illustrate that, in some embodiments, the system may not receive source information for all bidders, while it still may ensure (e.g., on the back end) that the source distribution may facilitate the flow of the consumers with the same attributes, j, have the same aggregate conversion and/or meet other quality metrics.

Disclosed embodiments may calculate the optimal bid for a fixed on minimum margin without using the win-rate function. For example, bidding module 109F may calculate the optimal bid independent of the win-rate function using the following formula:

bⱼₖ≤vⱼₖ·(1−mₖ)

where mₖ may represent the minimum margin target. In another example, rather than being less than, the formula may use an equality (equals sign) to perform a calculation for a fixed (e.g., static) margin.

Disclosed embodiments may also use different types of win rate functions, such as linear win-rate functions and asymptotic win-rate functions. For example, bidding module 109F may calculate a linear win rate function based on the following formula:

Rⱼₖ(bⱼₖ)=αⱼ+β·bⱼₖ

where constants include αⱼ<0 (which may represent no wins for a bid equal to zero), and βⱼ=0 (where a higher bid may result in a higher win rate). These two constants may be intrinsic parameters based on the auction conditions. For example, for a win rate greater than zero, the bid, bⱼₖ, may be greater than

$$\frac{- α}{{β}_{j}} .$$

Disclosed embodiments may apply the linear win rate function to different value propositions. For example, bidding module 109F may calculate:

$${b}_{jk} = \frac{{v}_{jk}}{2} - \frac{{α}_{j}}{2 \cdot {β}_{j}}$$

for maximum profit, Pⱼₖ. In another example, bidding module 109F may calculate:

$${b}_{jk} = - \frac{{α}_{j}}{2 \cdot {β}_{j}} \cdot [ 1 + 2 \cdot \sqrt{\frac{{β}_{j} \cdot {S}_{jk}}{{α}_{j}^{2}}} ]$$

for a spend rate target, Sⱼₖ.

Embodiments may use an asymptotic win-rate functions. For example, bidding module 109F may calculate:

$${R}_{jk} ( {b}_{jk} ) = {α}_{j} \cdot [ 1 - \frac{{β}_{j}}{{b}_{jk}} ]$$

where constants include αⱼ>0 (which may represent that the maximum win rate is positive), and βⱼ≥0 (where there are no wins for a bid equal to zero). These two constants may be intrinsic parameters based on the auction conditions. For example, for a win rate greater than zero, the bid, bⱼₖ, may be greater than βⱼ.

Disclosed embodiments may apply the asymptotic win-rate function to different value propositions. For example, bidding module 109F may calculate:

bⱼₖ=\sqrt{βⱼ·vⱼₖ}

for maximum profit, Pⱼₖ. In another example, bidding module 109F may calculate:

$${b}_{jk} = \frac{{S}_{jk}}{{α}_{j}} + {β}_{j}$$

for a spend rate target, Sⱼₖ.

Disclosed embodiments may use the linear and/or asymptotic win-rate functions to determine profitable bids for each bidder. The embodiments use of these functions to determine bids may provide the beneficial technical effect of reducing the bandwidth required to organize bids for online auctions. For example, absent the bid calculations, bidders may have to send excessive messages to signal changes to bids based on additional consumer information. By providing bidding module 109F and its associated functions, disclosed embodiments may be able to address the technical problem of bandwidth management. Disclosed embodiments may also provide additional computer functionality because, by reducing bandwidth needed to determine bids, disclosed embodiments may allow networks that could not previously host a repeat-auction computer process to host them due to the reduced bandwidth and network signaling provided by disclosed embodiments.

Tracking module 109E may be configured to track each won bid. For example, tracking module 109E may implement an accounting system to track which bids win (and which bids lose), as well as the features of each winning (and losing) bid. This enables deeper analysis to determine what features cause win/loss of a bid. Tracking module 109E may also keep track of the statistical aggregation of delivered quality for each bidder. Cookies may also be used to confirm that a requestor device 107A lands on a website of a bidder device 105A after that bidder submitted a winning bid.

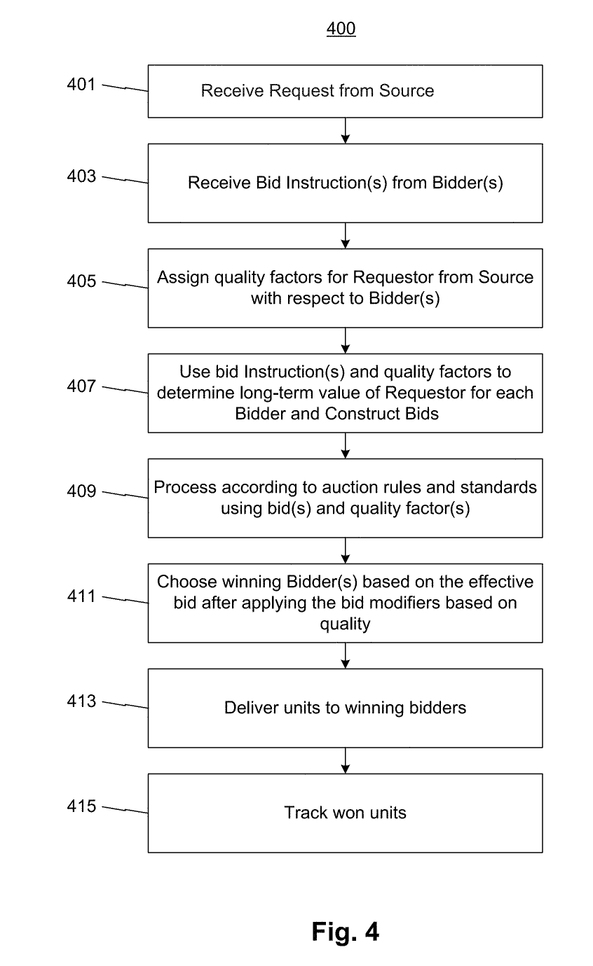

FIG. 4 is an exemplary method 400 of implementing a repeat-auction, consistent with disclosed embodiments.

Method 400 begins with step 401. In step 401, auction system 109 may receive one or more requests from one or more sources. Receiving the request may comprise directly receiving a request from a requestor device (e.g., requestor device 107B). Receiving the request may comprise indirectly receiving a request from a requestor device through a source that received a click or interaction from the requestor device (e.g., from requestor device 107A through organic source 103A, or from requestor device 107c through inorganic source 103B). The step of receiving the request may comprise receiving one or more of an identity of the requestor, demographics of the requestor, anonymized information of the requestor, details of a request of the requestor (e.g., a desired product or service, a desired price, or terms and conditions of the request), or the like.

Method 400 may then proceed to step 403. In step 403, auction system 109 may receive one or more bids and/or bid instructions from one or more bidder devices 105A-105C. In some embodiments, before receiving bids in step 403, auction system 109 may send a communication to bidder devices 105A-105C indicating the receipt of the request from the requestor in step 401. This communication may include details received in the request (e.g., identity, demographics, details of the request). In other embodiments, auction system 109 may receive bids from bidder devices 105A-105C without prompting from the auction system 109. For example, bidder devices 105A-105C may periodically send open bids to auction system 109.

Disclosed embodiments may group the requestors into biddable units. In certain embodiments, auction system 109 may organize requestors into groups so that bidders may make bids on an aggregated number of requestors. In some embodiments, auction system 109 can be configured to organize requestors into groups containing identical or similar requests. For example, auction system 109 can be configured to group a number of requestor (e.g., a predetermined number of requestors from 1-100 requestors) seeking a particular type of product and/or having a budget to spend within a predefined range. As a non-limiting example, in the context of the insurance industry requests may be grouped by type of automotive insurance (e.g., luxury automotive insurance versus state-minimum insurance).

Method 400 may then proceed to step 405. In step 405, auction system 109 may assign a quality value (also referred to as a quality factor) to the request received in step 401. For example, auction system 109 may assign a quality value based on the source that referred requestor device 107A to auction device 109, based on past actions taken by that requestor device 107A (e.g., purchases or quote requests) or other actions. As discussed above with respect to FIG. 3, this quality assessment step may be performed by quality module 1098, or may in other embodiments be performed by a different module or other system.

Disclosed embodiments may apply quality ratings to biddable units of requests. Auction system 109 may analyze individual requestors from biddable units and determine an overall or aggregate quality score for the biddable unit. For example, auction system 109 may determine descriptive statistics for a biddable unit based on the individual quality scores for each request of the biddable unit. Such descriptive statistics can include average quality score, range of quality scores, dispersion of quality scores, and the like. The auction system 109 may determine the overall or aggregate quality score for the biddable unit based on the descriptive statistics for the biddable unit.

In still other embodiments, auction system 109 may create biddable units including requestors having similar quality scores. Auction system 109 may determine individual quality scores for requests and create biddable units including requests with quality scores falling within a predetermined range. For example, auction system 109 may analyze individual requests (whether grouped into biddable units or not), determine a quality score for each of the requestors (e.g., using feedback module and the associated processes or any other quality calculations discussed in this disclosure), and form biddable units for the requests so that each request in the biddable unit has a quality score within a predetermined range. The biddable groups may allow bidders to place bids and apply it to a large group of requestors without the overhead of having to manage and bid on each individual request.

Method 400 may then proceed to step 407. In step 407, auction system 109 may determine the value of a requestor for each bidder and use that value to determine a bid for each bidder. The value for each requestor may be a long-term value for the bidder based on each bidder's instructions and quality factors for each requestor. For example, as discussed above with respect to bidding module 109F, valuing a bidder may comprise calculating the long-term value of the bidder-requestor relationship, the initial value, and/or a limited-term value, based on a determined quality factor.

Method 400 may then proceed to step 409. In step 409, auction system 109 may process bids for one or more bidders according to auction rules and standards, using the bid(s) and quality factor(s). For example, as discussed with regard to bidding module 109F, auction system 109 may determine a bid based on a value proposition and quality factor, among other potential considerations.

Although not shown in FIG. 4, method 400 may filter the determined bids. For example, filtering module 109C may remove certain bids as discussed with regard to the further description of filtering module 109C.

Method 400 may then proceed to step 411. In step 411, auction system 109 may choose at least one winning bidder. In certain embodiments, the selection may be based on one or more of the bids calculated in step 409, filtering performed by filtering module 109C, and/or the quality assessment in step 405. For example, auction system 109 can be configured to rank the bids in order of value and choose the highest bid as the “winning” bid. Auction system 109 may then debit or charge the bidder device associated with the winning bid by an amount (such as the value of the bid, the value of the first losing or second-highest bid, a modified value of the winning bid, or the like).

Method 400 may then proceed to step 413. In step 413, auction system 109 may deliver request information. In some embodiments, tracking module 109E and/or I/O module 109A can be configured to deliver the requests to winning bidder devices. In some embodiments, auction system 109 can deliver the request information to the at least one winning bidder. The request information can include the request, information concerning the requestor (e.g., contact information for the requestor such as a phone number or email address), or the like. In various embodiments, auction system 109 can deliver the request information to the requestor. The request information can include contact information for the at least one winning bidder, service information for each bidder (e.g., a rank list of advertisements for each bidder), or the like.

Method 400 may then proceed to step 415. In step 415, auction system 109 may track the results of the won bids. For example, as explained above, tracking module 109E may implement an accounting system to track which bids win (and which bids lose), as well as the features of each winning (and losing) bid. This enables deeper analysis to determine what features cause win/loss of a bid. Cookies may also be used to confirm that a requestor device 107A lands on a website of a bidder device 105A after that bidder submitted a winning bid.

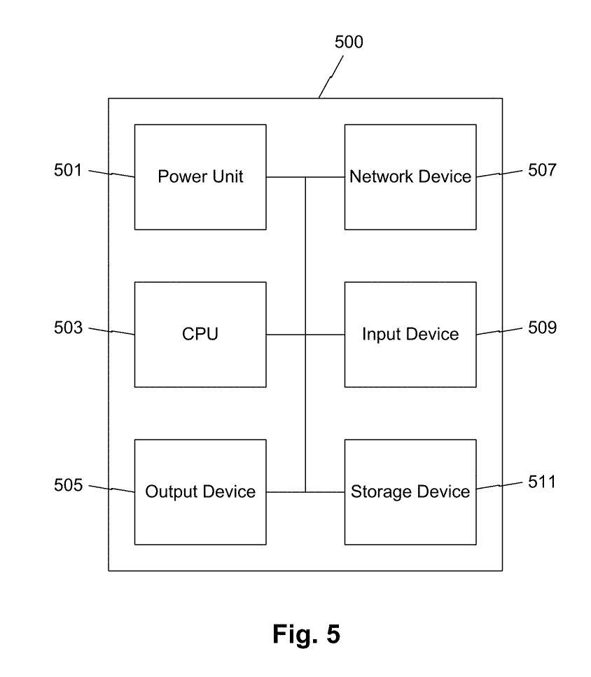

FIG. 5 depicts an exemplary electronic device 500, consistent with disclosed embodiments. Each component depicted in the preceding figures, including organic source(s) 103A, inorganic source(s) 1038, bidder device(s) 105A-105C, requestor device(s) 107A-107C, or auction system 109, may be implemented in part as illustrated in electronic device 500. In some embodiments, the components in FIG. 5 may be distributed across multiple physical devices, duplicated, substituted, or omitted. Each of the components in FIG. 5 can be connected to one another using, for example, a wired interconnection system such as a bus (shown in FIG. 5).

Device 500 comprises power unit 501. Power unit 501 can be implemented as a battery, a power supply, or the like. Power unit 501 provides the electricity necessary to power the other components in device 500. For example, CPU 503 needs power to operate. Power unit 501 can provide the necessary electric current to power this component.

Device 500 contains a Central Processing Unit (CPU) 503, which enables data to flow between the other components and manages the operation of the other components in electronic device 500. CPU 503, in some embodiments, can be implemented as a general-purpose processor (such as an Intel- or AMD-branded processor), a special-purpose processor (for example, a graphics-card processor or a mobile processor), or any other kind of processor that enables input and output of data.

device 500 also comprises output device 505. Output device 505 can be implemented as a monitor, printer, speaker, plotter, or any other device that presents data processed, received, or sent by electronic device 500.

Device 500 also comprises network adapter 507. Network adapter 507, in some embodiments, enables communication with other devices that are implemented in the same or similar way as electronic device 500. Network adapter 507, in some embodiments, may allow communication to and/or from a network such as the Internet. Network adapter 507 may be implemented using any or all of known or as-yet-unknown wired or wireless technologies (such as Ethernet, 802.11a/b/g/n (aka Wi-Fi), cellular (e.g. GSM, CDMA, LTE), or the like).

Device 500 also comprises input device 509. In some embodiments, input device 505 may be any device that enables a user or other entity to input data. For example, input device 509 could be a keyboard, a mouse, or the like. Input device 509 can be used to control the operation of the other components illustrated in FIG. 5.

Device 500 also includes storage device 511. Storage device 511 stores data that is usable by the other components in device 500. Storage device 511 may, in some embodiments, be implemented as a hard drive, temporary memory, permanent memory, optical memory, or any other type of permanent or temporary storage device. Storage device 511 may store one or more modules of computer program instructions and/or code that creates an execution environment for the computer program in question, such as, for example, processor firmware, a protocol stack, a database management system, an operating system, or a combination thereof.

The term “processor system,” as used herein, refers to one or more processors (such as CPU 503). The disclosed systems may be implemented in part or in full on various computers, electronic devices, computer-readable media (such as CDs, DVDs, flash drives, hard drives, or other storage), or other electronic devices or storage devices. The methods and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). While disclosed processes include particular process flows, alternative flows or orders are also possible in alternative embodiments.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. Furthermore, although aspects of the disclosed embodiments are described as being associated with data stored in memory and other tangible and/or non-transitory computer-readable storage mediums, one skilled in the art will appreciate that these aspects can also be stored on and executed from many types of tangible and/or non-transitory computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

What is claimed is:

1. A system, comprising:
at least one processor; and
at least one computer-readable medium containing operation instructions that, when executed by the at least one processor, cause the system to perform operations comprising:
receiving, by an input/output module:
a request from a device of a requestor, the request associated with an electronic source; and
instructions concerning the request from a bidder device of a bidder;
determining, by a quality module, a quality value for the requestor based on the electronic source associated with the request;
setting, by a bidding module, an amount based on the instructions and the quality value for the requestor;
choosing the bidder for the request based on the amount; and
providing, by a tracking module and the input/output module, request information.

2. The system of claim 1, wherein the amount further depends on requestor earnings events and conversion rates for the earnings events.

3. The system of claim 1, wherein the amount further depends on requestor earnings events and conversion rates for the earnings events over a predetermined time period.

4. The system of claim 3, wherein the time period is one of: one month, three months, six months, nine months, one year, two years, five years, or ten years.

5. The system of claim 1, wherein the amount further depends on a product of an initial requestor earnings event and a conversion rate corresponding to the initial requestor earnings event.

6. The system of claim 1, wherein the amount further depends on a product of:
summed expected earnings of the bidder from the requestor over a life expectancy of a relationship between the bidder and the requestor, and
a conversion rate corresponding to a likelihood of the summed expected earnings.

7. The system of claim 1,
the operations further comprising receiving, by the quality module, one or more quality events, the one or more quality events indicating that the requestor previously requested information related to the request, fulfilled a prior request related to the request, or a preexisting relationship with the bidder; and
wherein the quality module determines the quality value for the requestor using the one or more quality events.

8. The system of claim 7, wherein
the one or more quality events are associated with corresponding dates; and
wherein determining the quality value using the one or more quality events comprises:
identifying quality events of the one or more quality events with corresponding dates within a predetermined time period; and
calculating the quality value based on the identified quality events.

9. The system of claim 8, wherein the predetermined time period is one of: from present to an hour ago, from present to 24 hours ago, from present to a day ago, from present to seven days ago, from present to a month ago.

10. The system of claim 1, wherein the instructions include a target profit amount.

11. The system of claim 1, wherein the instructions include a target profit margin.

12. The system of claim 1, wherein the instructions include a budget.

13. The system of claim 12, wherein the instructions further include a time period for using the budget.

14. The system of claim 1,
the operations further comprising:
receiving a plurality of requests;
determining the quality value for each of the plurality of requests; and
organizing requests from the plurality of requests having quality values within a predetermined range of quality values into a biddable unit having an aggregate quality value;
wherein setting the amount comprises setting the amount based on the aggregate quality value;
wherein choosing the bidder for the request comprises choosing the bidder for the biddable unit.

15. The system of claim 1,
the operations further comprising:
receiving a plurality of requests;
forming a biddable unit that includes the plurality of requests; and
determining an aggregate quality value for the biddable unit;
wherein setting the amount comprises setting the amount based on the aggregate quality value;
wherein choosing the bidder for the request comprises choosing the bidder for the biddable unit.

16. The system of claim 10, wherein the instructions include a spend rate.

17. The system of claim 16, wherein setting the amount is further based on a linear win-rate model using the spend rate.

18. The system of claim 16, wherein setting the amount is further based on an asymptotic win-rate model using the spend rate.

19. A computer-implemented method for performing online repeat-auctions, comprising:
receiving, by an input/output module:
a request from a device of a requestor, the request associated with an electronic source; and
instructions concerning the request from a bidder device of a bidder;
determining, by a quality module, a quality value for the requestor based on the electronic source associated with the request;
setting, by a bidding module, an amount based on the instructions and the quality value for the requestor;
choosing the bidder for the request based on the amount; and
delivering, by a tracking module and the input/output module, request information to the device of the bidder.

20. A non-transitory computer-readable medium storing operation instructions, the operation instructions configured to cause at least one electronic processor to perform a method for performing online repeat-auctions, the method comprising:
receiving, by an input/output module:
a request from a device of a requestor, the request associated with an electronic source; and
instructions concerning the request from a bidder device of a bidder; determining, by a quality module, a quality value for the requestor based on the electronic source associated with the request;
setting, by a bidding module, an amount based on the instructions and the quality value for the requestor;
choosing the bidder for the request based on the amount; and
delivering, by a tracking module and the input/output module, request information to the device of the bidder.
